(19) United States
(12) Patent Application Publication
(10) Pub. No.: US 2025/0286165 A1
(43) Pub. Date: Sep. 11, 2025

(54) HOUSING COVER, BATTERY MODULE, AND BATTERY PACK

(71) Applicant: SAMSUNG SDI CO., LTD., Yongin-si (KR)

(72) Inventor: Seungbum KIM, Yongin-si (KR)

(21) Appl. No.: 18/786,792

(22) Filed: Jul. 29, 2024

(30) Foreign Application Priority Data
Mar. 11, 2024 (KR) 10-2024-0033939

(51) Int. Cl. H01M 10/6551; H01M 50/278; H01M 50/342

(52) U.S. Cl. CPC H01M 10/6551; H01M 50/278; H01M 50/3425

(57) ABSTRACT

A battery module is provided that includes a plurality of heat dissipating fins. The battery module includes a battery cell, a module housing accommodating the battery cell and including an open upper portion, and a housing cover coupled to the upper portion of the module housing. The housing cover includes a plurality of heat dissipating fins.

### CROSS REFERENCE TO RELATED APPLICATION

The present application claims priority to and the benefit of Korean Application No. 10-2024-0033939, filed on Mar. 11, 2024, in the Korean Intellectual Property Office, the entire disclosure of which is incorporated by reference herein.

### BACKGROUND

### 1. Field

The present disclosure relates to a housing cover, a battery module, and a battery pack. In particular, the present disclosure relates to a housing cover including heat dissipating fins, and a battery management module and a battery pack including the housing cover.

### 2. Description of the Related Art

Secondary batteries are rechargeable batteries referring that may be charged and discharged a plurality of times. Such secondary batteries are mainly used in various applications such as electronics (e.g., smartphones, laptops, and tablets), electric vehicles, solar power generation, and emergency power supplies. In particular, lithium-ion batteries are used in a variety of electronics and electric vehicles due to high energy density and high charge and discharge efficiency thereof.

Secondary batteries, especially lithium-ion batteries, may degrade rapidly when they are exposed to high temperatures for extended periods of time, so efficient thermal management of the battery is desired. On the other hand, a flame-retardant plastic battery housing may be provided to prevent flames generated outside the battery from entering the battery. And the flame-retardant plastic battery housing has a problem in that dissipation of heat generated by the battery to the outside is reduced by the plastic battery housing. The plastic battery housing also has a problem of generating battery heat due to external impacts.

The above information disclosed in this Background section is for enhancement of understanding of the background of the present disclosure, and therefore, it may contain information that does not constitute related (or prior) art.

### SUMMARY

The present disclosure provides a housing cover including heat dissipating fins, a battery management module, and a battery pack configured to solve at least one of the above-described problems.

These and other aspects and features of the present disclosure will be described in or will be apparent from the following description of embodiments of the present disclosure.

A battery module according to one or more embodiments of the present disclosure may include a battery cell, a module housing accommodating the battery cell and including an open upper portion, and a housing cover coupled to the upper portion of the module housing and including a plurality of heat dissipating fins.

At least one heat dissipating fin of the heat dissipating fins may extend in a longitudinal direction of the battery module and protrudes from a surface of the housing cover, and a first heat dissipating fin of the heat dissipating fins may be spaced from a second heat dissipating fin of the heat dissipating fins that is adjacent to the first heat dissipating fin in a transverse direction of the battery module.

At least one heat dissipating fin of the heat dissipating fins may extend in a transverse direction of the battery module and protrudes from a surface of the housing cover, and a first heat dissipating fin of the heat dissipating fins may be spaced from a second heat dissipating fin of the heat dissipating fins that is adjacent to the first heat dissipating fin in a longitudinal direction of the battery module.

At least one heat dissipating fin of the heat dissipating fins may be columnar, the heat dissipating fins may be spaced from each other heat may protrude from a surface of the housing cover.

The housing cover includes a resin material region.

A position of the resin material region may correspond to a position of a vent provided in the battery cell when the housing cover is coupled to the open upper portion of the module housing.

The resin material region may be melted, sublimated, or dissolved by gases exhausting through a vent provided in the battery cell.

The resin material region may be melted, sublimated, or dissolved when a thermal event in the battery cell accommodated in the module housing.

At least one heat dissipating fin of the heat dissipating fins may extend in a longitudinal direction of the battery module and protrudes from a surface of the housing cover, and the resin material region may be provided between a first dissipating fin of the heat dissipating fins and a second heat dissipating fin of the heat dissipating fins that is adjacent to the first heat dissipating fin, and the resin material region extends in a longitudinal direction of the battery module.

At least one heat dissipating fin of the heat dissipating fins may extend in a transverse direction of the battery module and protrudes from a surface of the housing cover, and the resin material region may be provided between a first heat dissipating fin of the heat dissipating fins and a second heat dissipating fin of the heat dissipating fins that is adjacent to the first heat dissipating fin, and the resin material region extends in the transverse direction of the battery module.

At least one heat dissipating fin of the heat dissipating fins may be columnar, and the resin material region may be provided between a first group of the heat dissipating fins and a second group of the heat dissipating fins arranged in a longitudinal direction of the battery module, and the resin material region extends in the longitudinal direction of the battery module.

At least one heat dissipating fin of the heat dissipating fins may be columnar, and the resin material region may be provided between a first group of heat dissipating fins and a second group of heat dissipating fins among the heat dissipating fins arranged in a transverse direction of the battery module.

A housing cover according to another embodiment may be coupled to an upper portion of a module housing configured to accommodate a battery cell according to one or more embodiments of the present disclosure may include a heat dissipating plate, a plurality of heat dissipating fins provided to protrude from an upper portion of the heat dissipating plate, and at least one resin material region provided on the heat dissipating plate.

The resin material region may be provided in at least a region of the heat dissipating plate between the heat dissipating fins.

The resin material region may include a plurality of resin material regions and each resin material region of the resin material regions may be arranged in at least a region of the heat dissipating plate between the heat dissipating fins and spaced from adjacent resin material regions.

A position of the resin material region may correspond to a position of a vent provided in the battery cell when the housing cover is coupled to an upper portion of the module housing and the battery cell is accommodated in the module housing.

The resin material region may be melted, sublimated, or dissolved by gases exhausting through a vent provided in the battery cell accommodated in the module housing.

The resin material region may be melted, sublimated, or dissolved when a thermal event occurs in the battery cell accommodated in the module housing.

One or more embodiments of the present disclosure, a battery pack may that include a battery module accommodating a battery cell, a pack housing accommodating the battery module and including an open upper portion, and a pack housing cover coupled to an upper portion of the pack housing and including a plurality of heat dissipating fins protruding from an upper portion of a heat dissipating plate.

The pack housing cover may include a resin material region provided in at least a region of the heat dissipating plate between the heat dissipating fins.

According to some embodiments of the present disclosure, heat generated inside the battery module may be efficiently dissipated to outside of the battery module by the heat dissipating fins provided in the housing cover.

According to some embodiments of the present disclosure, at least a portion of the housing cover may be opened when thermal events occur in the battery cell, and heat generated by the battery module may be more efficiently dissipated through the open portion.

According to some embodiments of the present disclosure, the strength of the battery module may be improved by the heat dissipating fin structures protruding vertically from the surface of the housing cover.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective diagram showing an example of a battery cell 10 according to embodiments of the present disclosure.

FIG. 2 illustrates a perspective diagram showing an example of a battery module 1 according to embodiments of the present disclosure.

FIG. 3 illustrates a side diagram showing the battery module 1 including a plurality of heat dissipating fins according to embodiments of the present disclosure. In addition,

FIG. 4 illustrates a front diagram showing the battery module including the heat dissipating fins according to embodiments of the present disclosure.

FIG. 5 illustrates a plan diagram showing the housing cover including resin material regions according to embodiments of the present disclosure.

FIG. 6 illustrates a plan diagram showing the housing cover including a plurality of resin material regions and according to embodiments of the present disclosure.

FIG. 7 illustrates a plan diagram showing the housing cover including a resin material region according to embodiments of the present disclosure.

FIG. 8 illustrates a front diagram showing the battery module including the housing cover of FIG. 7.

FIG. 9 illustrates a side diagram showing the battery module provided with a plurality of heat dissipating fins according to embodiments of the present disclosure.

FIG. 10 illustrates a front diagram showing the battery module provided with the

FIG. 11 illustrates a plan diagram showing the housing cover including resin material regions according to embodiments of the present disclosure.

FIG. 12 illustrates a plan diagram showing the housing cover including resin material regions according to embodiments of the present disclosure.

FIG. 13 illustrates a front diagram showing the battery module including the housing cover in FIG. 12.

FIG. 14 illustrates a perspective diagram showing the battery module provided with the columnar heat dissipating fins according to embodiments of the present disclosure.

FIG. 15 illustrates a side diagram showing the battery module provided with the columnar heat dissipating fins according to embodiments of the present disclosure.

FIG. 16 illustrates a front diagram showing the battery module provided with the columnar heat dissipating fins according to embodiments of the present disclosure.

FIG. 17 illustrates a plan diagram showing the housing cover provided with the columnar heat dissipating fins according to embodiments of the present disclosure.

FIG. 18 illustrates a plan diagram showing the housing cover including the resin material regions according to embodiments of the present disclosure.

FIG. 19 illustrates a plan diagram showing the housing cover including the resin material regions according to embodiments of the present disclosure.

### DETAILED DESCRIPTION OF THE EMBODIMENTS

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

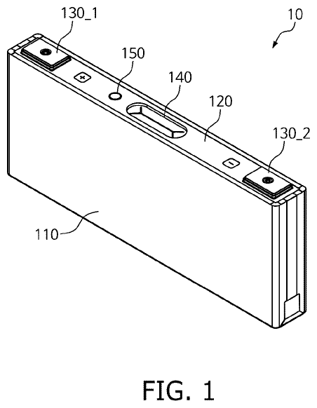

FIG. 1 illustrates a perspective diagram showing an example of a battery cell 10 according to embodiments of the present disclosure. Referring to FIG. 1, a battery cell 10 may include one or more wound or laminated electrode assemblies with a separator, i.e., an insulator, provided between a positive electrode and a negative electrode. A case 110 accommodates the electrode assemblies, and a cap plate 120 is coupled to an open end of the case 110. The battery cell 10 shown in FIG. 1 may be a type of secondary cell.

Each of the positive electrode and the negative electrode may include a current collector made of a thin metal foil having a coated portion on which an active material is coated and an uncoated portion on which an active material is not coated.

The positive electrode and the negative electrode are wound after interposing the separator, which is an insulator, therebetween. However, the present disclosure is not limited thereto, and the electrode assemblies may have a structure in which a positive electrode and a negative electrode, each made of a plurality of sheets, are alternately stacked with a separator interposed therebetween.

The case 110 may form the overall outer appearance of the secondary battery 10 and may be made of a conductive metal, such as aluminum, aluminum alloy, or nickel-plated steel. In addition, the case 110 may provide a space in which the electrode assemblies are accommodated. In FIG. 1, the case 110 is shown as a prismatic case and the battery cell 10 is shown as a prismatic battery cell, but the scope of the present disclosure is not limited thereto. The battery cell 10 can be a battery cell having any shape, such as a prismatic battery cell, a cylindrical battery cell, or a pouch battery cell.

The cap plate 120 may be coupled to the open end of the case 110 to seal the case 110. The case 110 and the cap plate 120 may be formed of a conductive material. In an embodiment, the top end of the case 110 may be open, and the cap plate 120 may seal the open top end of the case 110.

A positive electrode terminal 130_1 electrically connected to the negative electrode and a negative electrode terminal 130_2 electrically connected to the positive electrode may be coupled to the cap plate 120. The positive and negative terminals 130_1 and 130_2 may be disposed to protrude outwardly through the cap plate 120.

According to an embodiment, a vent 140 may be formed on at least one side of the battery cell 10 (e.g., the top side of the battery cell 10, i.e., the cap plate 120 in the shown example). The vent 140 may be configured to open when an internal pressure equal to or higher than a predetermined threshold pressure is detected in the battery cell 10.

In an embodiment, the cap plate 120 may include an electrolyte inlet 150. The electrolyte inlet 150 may be a through-hole provided in the cap plate 120, and the electrolyte inlet 150 may be formed such that electrolyte is injected into the case 110 through the electrolyte inlet 150 after the cap plate 120 is coupled to an opening in the case 110. Thus, the case 110 is tightly closed. After the electrolyte is injected, the electrolyte inlet 150 may be tightly closed using a sealing member.

The battery cell 10 may be a lithium (Li) battery cell, a sodium (Na) battery cell, or the like. However, the scope of the present disclosure is not limited thereto, and the battery cell 10 be any battery capable of repeatedly providing electricity by being charged and discharged. In an embodiment in which the battery cell 10 is a Li battery cell, the battery cell 10 may be used in an electric vehicle (EV) due to its superior lifetime characteristics and superior high-rate characteristics. The battery cell 10 may be used, for example, in a hybrid vehicle such as a plug-in hybrid electric vehicle (PHEV). In addition, the Li battery cell may be used in an application in which a large amount of power storage is used. For example, the Li battery cell may be used in electric bicycles, power tools, and the like.

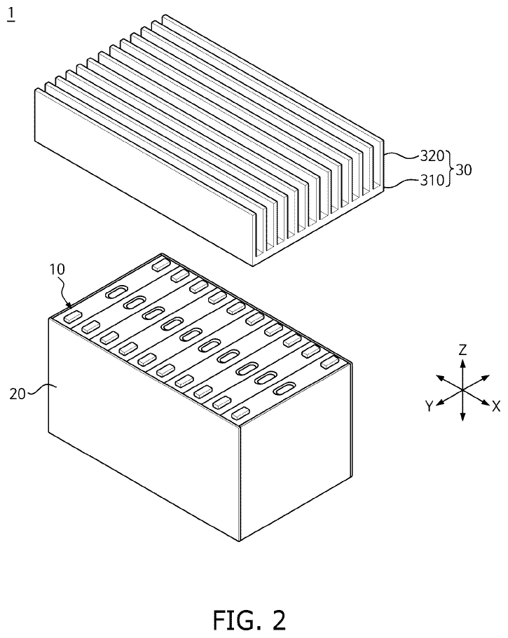

FIG. 2 illustrates a perspective diagram showing an example of a battery module 1 according to embodiments of the present disclosure. Referring to FIG. 2, the battery module 1 may include a battery cell 10, a module housing 20, and a housing cover 30. According to an embodiment, the battery module 1 may refer to a battery pack. In addition, according to an embodiment, the battery module 1 may be included in a vehicle.

Herein, the battery cell 10 may refer to a battery cell assembly. In an embodiment, a plurality of battery cells 10 may be arranged inside the module housing 20 in the longitudinal direction of the battery module (e.g., in the X-axis direction) to form a battery cell assembly. In another embodiment, the battery cells 10 may be stacked inside the module housing 20 in the height direction of the battery module (e.g., in the Z-axis direction) to form a battery cell assembly.

The module housing 20 may include an internal space in which a battery cells 10 are accommodated. The battery cell 10 may be inserted and disposed in the internal space of the module housing 20 through the open upper portion of the module housing 20.

The housing cover 30 may be coupled to the upper portion of the module housing 20 in a state where the battery cells are disposed inside the module housing 20. In an embodiment, the housing cover 30 may be a formed from a metal material having high thermal conductivity. For example, the housing cover 30 may be formed from an aluminum alloy. In another example, the housing cover 30 may be formed from a steel alloy material. But the metal material of the housing cover 30 is not limited to these examples.

The housing cover 30 may include a plurality of heat dissipating fins 320. In particular, the housing cover 30 may include a heat dissipating plate 310 and a plurality of heat dissipating fins 320 connected to the heat dissipating plate 310. In this case, the heat dissipating fins 320 may be formed to protrude from the upper portion of the heat dissipating plate 310.

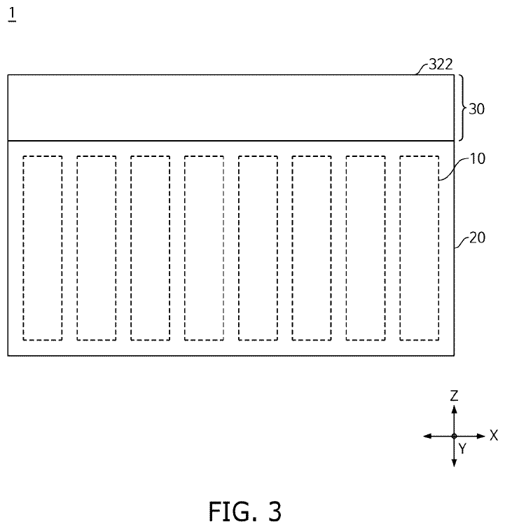

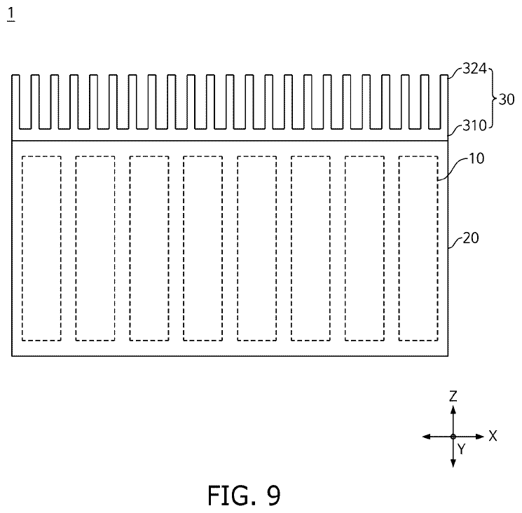

At least one heat dissipating fin among the heat dissipating fins 320 may be a plate-shaped heat dissipating fin. In an embodiment, at least one heat dissipating fin among the heat dissipating fins 320 may extend in the longitudinal direction of the battery module and may protrude from the surface of the housing cover 30, i.e., the upper portion of the heat dissipating plate 310. A specific configuration of such an embodiment will be described in more detail below with reference to FIGS. 3 to 8. In another embodiment, at least one heat dissipating fin among the heat dissipating fins 320 may extend in the transverse direction of the battery module and may protrude from a surface of the housing cover 30, i.e., the upper portion of the heat dissipating plate 310. A specific configuration of such an embodiment will be described in more detail below with reference to FIGS. 9 to 13.

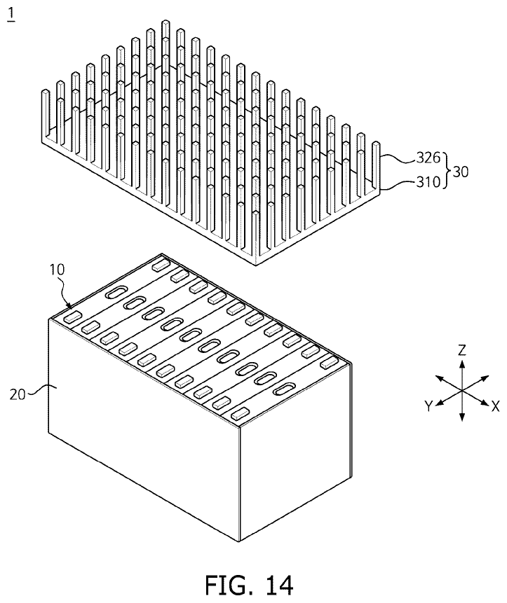

In an embodiment, at least one heat dissipating fin among the heat dissipating fins 320 may be a columnar heat dissipating fin, and one heat dissipating fin among the heat dissipating fins 320 may have a shape spaced from other adjacent heat dissipating fins and protrude from the surface of the housing cover. A specific configuration of such an embodiment will be described in more detail with reference to FIGS. 14 to 19.

The shape of the heat dissipating fins 320 is not limited to the examples described above. In an example, each of the heat dissipating fins 320 may be a plate-shaped heat dissipating fin including at least one or more curved portions. In another example, each of the heat dissipating fins 320 may be a vertically shaped columnar heat dissipating fin, a columnar heat dissipating fin including at least one or more curved portions, or a columnar heat dissipating fin including at least one or more twisted portions. In addition, the cross-sectional shape of the heat dissipating fin 320 is not limited to a rectangular shape and may be of a variety of shapes. For example, the cross-sectional shape of the heat dissipating fin 320 may be a triangle, a circle, or a polygon.

Due to the heat dissipating fins 320 being provided on the housing cover 30, heat generated inside the battery module may be efficiently dissipated from the battery module 100. In addition, due to the heat dissipating fin structure protruding vertically from the surface of the housing cover 30, the strength of the battery module may be improved.

According to an embodiment, the housing cover 30 may include a resin material region. The resin material region may include, for example, a thermoplastic resin such as polycarbonate, polyethylene, polypropylene, acrylonitrile butadiene styrene (ABS) resin, polyamide, nylon, or polyaryletherketone (PAEK). In another example, the resin material region may include a thermosetting resin such as epoxy resin, polyimide resin, phenolic resin, or silicone resin. The materials used in the resin material region are not limited to these examples. In addition, a material including not only one type of resin but also a mixture of two or more types of resin may be used in the resin material region.

According to the configuration described above, at least a portion of the resin material region of the housing cover 30 may be opened due to thermal events in the battery cell, and heat generated by the battery module may be efficiently dissipated through the open portion.

According to an embodiment, a battery pack (not shown) may include a battery module configured to accommodate battery cells, a pack housing having an open upper portion and accommodating the battery module, and a pack housing cover coupled to the upper portion of the pack housing and including a plurality of heat dissipating fins protruding from the upper portion of a heat dissipating plate. Here the pack housing cover may include a resin material region provided in at least a portion of the region of the heat sink between the heat dissipating fins. The configuration of the pack housing cover coupled to the upper portion of the battery pack may be the same as or similar to the module housing cover described herein.

FIGS. 3 to 8 illustrate examples of the housing cover including a plurality of heat dissipating fins extending in the longitudinal direction of the battery module 1.

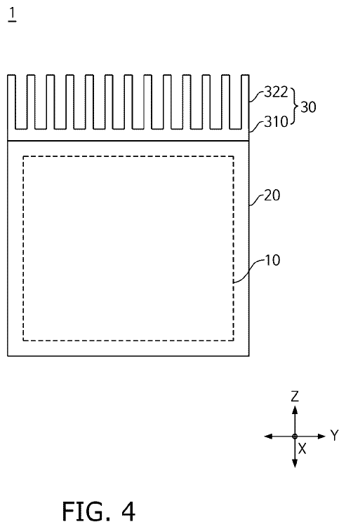

FIG. 3 illustrates a side diagram showing the battery module 1 including a plurality of heat dissipating fins 322 according to embodiments of the present disclosure. In addition, FIG. 4 illustrates a front diagram showing the battery module 1 including the heat dissipating fins 322 according to embodiments of the present disclosure. The battery module 1 may include the battery cells 10, the module housing 20 accommodating the battery cells 10, and the housing cover 30 coupled to the upper portion of the module housing 20. According to an embodiment, at least one heat dissipating fin among the heat dissipating fins 322 may be a plate-shaped heat dissipating fin.

Referring to FIGS. 3 and 4, at least one heat dissipating fin among the heat dissipating fins 322 may extend in the longitudinal direction (e.g., the X-axis direction) of the battery module 1 to protrude from the upper portion of the heat dissipating plate 310. In this case, one heat dissipating fin among the heat dissipating fins 322 may be arranged to be spaced from other adjacent heat dissipating fins among the heat dissipating fins 322 in the transverse direction (e.g., the Y-axis direction) of the battery module 1.

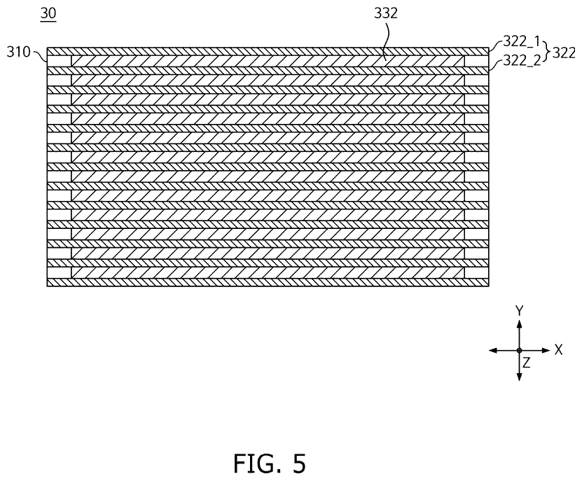

FIGS. 5 to 8 illustrate embodiments in which resin material regions 332, 332_1, 332_2, and 334 are provided in a portion of the housing cover 30 in an embodiment of the housing cover 30 including the heat dissipating fins 322 extending in the longitudinal direction of the battery module 1.

FIG. 5 illustrates a plan diagram showing the housing cover 30 including resin material regions 332 according to embodiments of the present disclosure. The housing cover 30 according to an embodiment may include the resin material regions 332. The resin material regions 332 may be positioned on a heat dissipating plate 312 between the heat dissipating fins 322. Referring to FIG. 5, the resin material regions 332 may be provided between one heat dissipating fin 322_1 and another adjacent heat dissipating fin 322_2 among the heat dissipating fins 322, with the resin material regions 332 may extend in the longitudinal direction (e.g., the X-axis direction) of the battery module.

In FIG. 5, each of the resin material regions 332 is shown to be provided between two adjacent heat dissipating fins among the heat dissipating fins 322, but is not limited thereto. In an embodiment, the resin material regions 332 may be provided between at least some adjacent heat dissipating fins among the heat dissipating fins 322, and no resin material regions may be provided between the remaining adjacent heat dissipating fins.

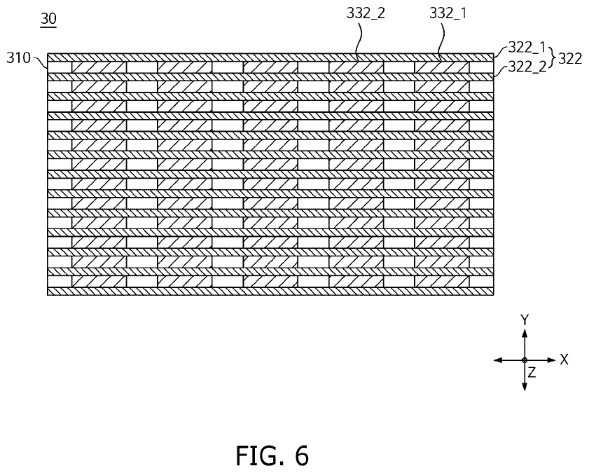

FIG. 6 illustrates a plan diagram showing the housing cover 30 including a plurality of resin material regions 332_1 and 332_2 according to embodiments of the present disclosure. According to an embodiment, each of the resin material regions 332 provided between one heat dissipating fin 322_1 and another adjacent heat dissipating fin 322_2 may include the resin material regions 332_1 and 332_2. In this case, the resin material regions 332_1 and 332_2 may be spaced from each other in at least a region of the heat dissipating plate 312 between two adjacent heat dissipating fins 322 among the heat dissipating fins 322. Referring to FIG. 6, the resin material regions 332_1 and 332_2 may be provided between one heat dissipating fin 322 and another adjacent heat dissipating fin 322_2 among the heat dissipating fins 322 to extend in the longitudinal direction (e.g., the X-axis direction) of the battery module.

In FIG. 6, the resin material regions 332_1 and 332_2 are shown to be provided between two adjacent heat dissipating fins among the heat dissipating fins 322, but the resin material regions 332_1 and 332_2 are not limited thereto. In an embodiment, a single resin material region (e.g., 332 in FIG. 5) may be provided between at least two adjacent heat dissipating fins among the heat dissipating fins 322, and the resin material regions 332_1 and 332_2 may be provided between two other adjacent heat dissipating fins to be spaced from each other. In another embodiment, a single resin material region (e.g., 332 in FIG. 5) may be provided between two adjacent heat dissipating fins among the heat dissipating fins 322, the resin material regions 332_1 and 332_2 may be provided between two other adjacent heat dissipating fins among the heat dissipating fins 322, and no resin material regions may be provided between two other adjacent heat dissipating fins among the heat dissipating fins 322.

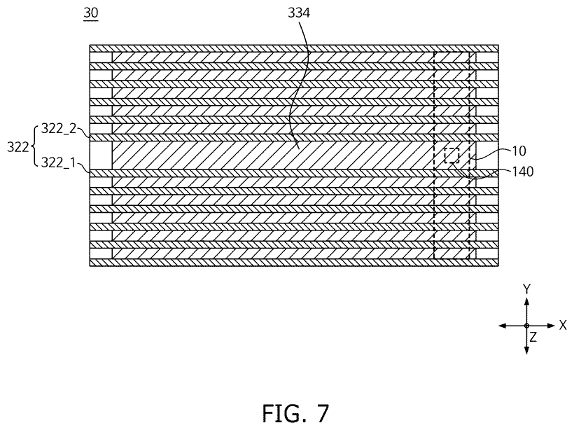

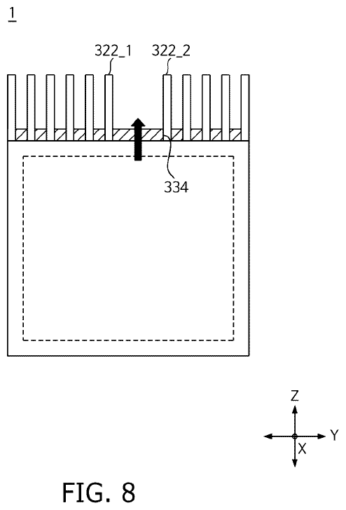

FIG. 7 illustrates a plan diagram showing the housing cover 30 including a resin material region 334 according to embodiments of the present disclosure. FIG. 8 illustrates a front diagram showing the battery module 1 including the housing cover 30 of FIG. 7. According to an embodiment, the position of one resin material region 334 among the resin material regions 334 may correspond to the position of the vent 140 provided in the battery cell 10 in a case where the housing cover 30 is coupled to the upper portion of the module housing. The resin material region 334 may be provided between the first heat dissipating fin 322_1 and the second heat dissipating fin 322_2 to extend in the longitudinal direction of the battery module may correspond to the position of the vent 140 provided in the battery cell 10. In this case, the resin material region 334 may be configured to be melted, sublimated, or dissolved by gases exhausting through the vent 140 so that the vent 140 is opened.

According to the configuration described above, at least a portion of the housing cover 30 may be opened due to thermal events in the battery cells. Thus, heat generated by the battery module may be efficiently dissipated through the open portion.

FIGS. 9 to 13 illustrate examples of the housing cover 30 provided with a plurality of heat dissipating fins extending in the transverse direction of the battery module 1.

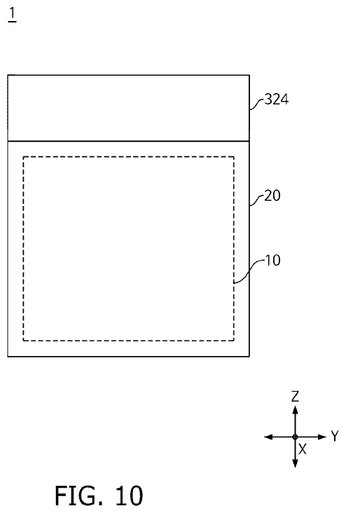

FIG. 9 illustrates a side diagram showing the battery module 1 provided with a plurality of heat dissipating fins 324 according to embodiments of the present disclosure. FIG. 10 illustrates a front diagram showing the battery module 1 provided with the heat dissipating fins 324 according to embodiments of the present disclosure. Referring to FIGS. 9 and 10, at least one heat dissipating fin among the heat dissipating fins 324 may extend in the transverse direction (e.g., the Y-axis direction) of the battery module 1 to protrude from the upper portion of the heat dissipating plate 310. In this case, one heat dissipating fin among the heat dissipating fins 324 may be arranged to be spaced from another heat dissipating fin in the longitudinal direction (e.g., the X-axis direction) of the battery module 1.

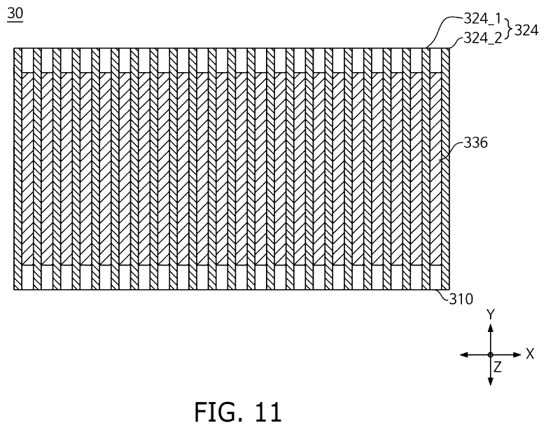

FIGS. 11 to 13 illustrate embodiments in which resin material regions 336 and 338 are formed in a portion of the housing cover 30 in an embodiment of the housing cover 30 including a plurality of heat dissipating fins extending in the transverse direction of the battery module 1.

FIG. 11 illustrates a plan diagram showing the housing cover 30 including resin material regions 336 according to embodiments of the present disclosure. According to an embodiment, the resin material regions 336 may be provided on the heat dissipating plate 310 to extend in the transverse direction of the battery module (e.g., in the Y-axis direction). Referring to FIG. 11, the resin material regions 336 may be provided to extend in the transverse direction of the battery module between one heat dissipating fin 324_1 and another adjacent heat dissipating fin 324_2 among the heat dissipating fins 320.

In FIG. 11, each of the resin material regions 336 is shown to be provided between two adjacent heat dissipating fins among the heat dissipating fins 324, but the resin material regions 336 are not limited thereto. In an embodiment, no resin material regions may be provided between at least two adjacent heat dissipating fins among the heat dissipating fins 324. In another embodiment, a single resin material region 336 may be provided between at least two adjacent heat dissipating fins among the heat dissipating fins 324, and a plurality of resin material regions may be provided between two other adjacent heat dissipating fins among the heat dissipating fins 324. In another embodiment, a single resin material region 336 may be provided between two adjacent heat dissipating fins among the heat dissipating fins 324, a plurality of resin material regions may be provided between two other adjacent heat dissipating fins among the heat dissipating fins 324, and no resin material regions may be provided between two other adjacent heat dissipating fins among the heat dissipating fins 324.

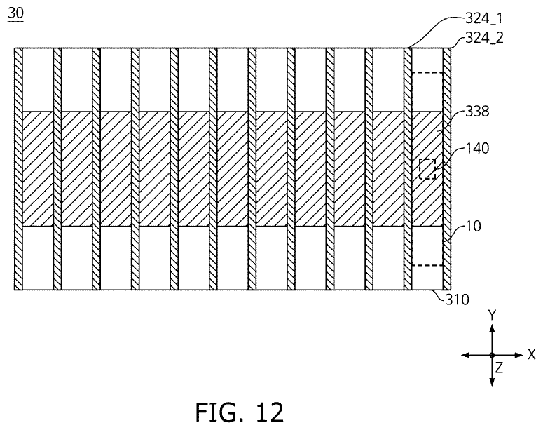

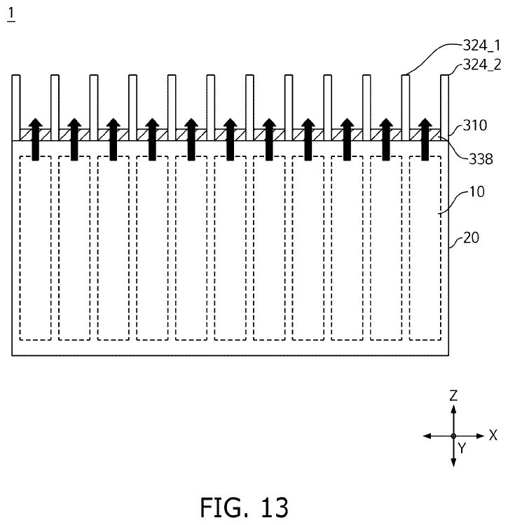

FIG. 12 illustrates a plan diagram showing the housing cover 30 including resin material regions 338 according to embodiments of the present disclosure. FIG. 13 illustrates a front diagram showing the battery module 1 including the housing cover 30 in FIG. 12. According to an embodiment, the position of one resin material region among the resin material regions 338 may correspond to the position of the vent 140 provided in the battery cell 10 in a case where the housing cover 30 is coupled to the upper portion of the module housing 20. For example, the resin material region 338 provided on the heat dissipating plate 310 between the first heat dissipating fin 324_1 and the second heat dissipating fin 324_2 and extending in the transverse direction of the battery module may correspond to the position of the vent 140 provided in the battery cell 10. In this case, the resin material region 338 may be configured to be melted, sublimated, or dissolved by gases exhausting through the vent 140 so that the vent 140 is opened.

According to the configuration described above, at least a portion of the housing cover 30 may be opened due to thermal events in the battery cells. Thus, heat generated by the battery module may be efficiently dissipated through the open portion.

FIGS. 14 to 19 illustrate examples of the housing cover 30 provided with a plurality of columnar heat dissipating fins 326.

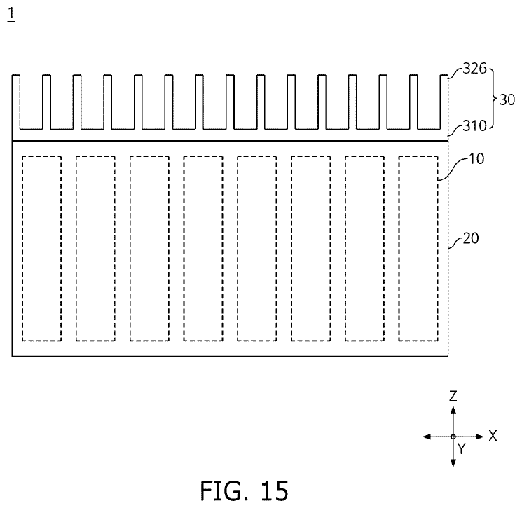

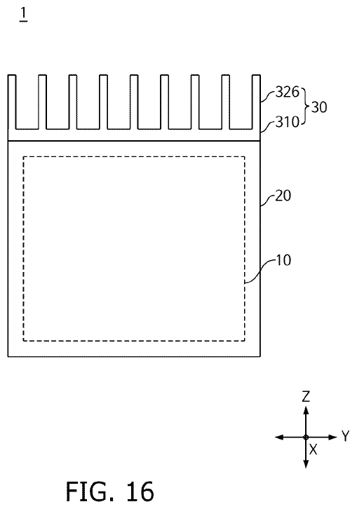

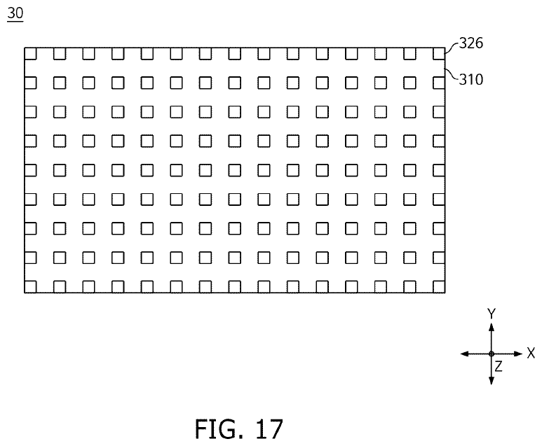

FIG. 14 illustrates a perspective diagram showing the battery module 1 provided with the columnar heat dissipating fins 326 according to embodiments of the present disclosure. FIG. 15 illustrates a side diagram showing the battery module 1 provided with the columnar heat dissipating fins 326 according to embodiments of the present disclosure. FIG. 16 illustrates a front diagram showing the battery module 1 provided with the columnar heat dissipating fins 326 according to embodiments of the present disclosure. FIG. 17 illustrates a plan diagram showing the housing cover 30 provided with the columnar heat dissipating fins 326 according to embodiments of the present disclosure. The battery module 1 may include the battery cells 10, the module housing 20 accommodating the battery cells 10, and the housing cover 30 coupled to the upper portion of the module housing 20. Most of the foregoing description of the battery module 1 with reference to FIG. 2 applies to the battery module 1 in FIGS. 14 to 16.

In an embodiment, at least one heat dissipating fin among the heat dissipating fins 326 may be a columnar heat dissipating fin. Further, one heat dissipating fin among the heat dissipating fins 326 may be spaced from other neighboring heat dissipating fins and provided to protrude from the surface of the housing cover, i.e., the upper portion of the heat dissipating plate 310. For example, the heat dissipating fins 326 may be provided on the upper portion of the heat dissipating plate 310 in the form of a matrix where the heat dissipating fins 326 are spaced apart at regular intervals in the transverse direction (e.g., in the Y-axis direction) and the longitudinal direction (e.g., in the X-axis direction) of the battery module 1 and the heat dissipating finds 326 protrude from the upper portion of the heat dissipating plate 310.

The columnar heat dissipating fins 326 in the housing cover 30 provide an increased the cross-sectional area, thereby allowing heat generated inside the battery module to dissipate more efficiently to outside of the battery module 100. In addition, due to the heat dissipating fin structure protruding vertically from the surface of the housing cover 30, the strength of the battery module may be improved.

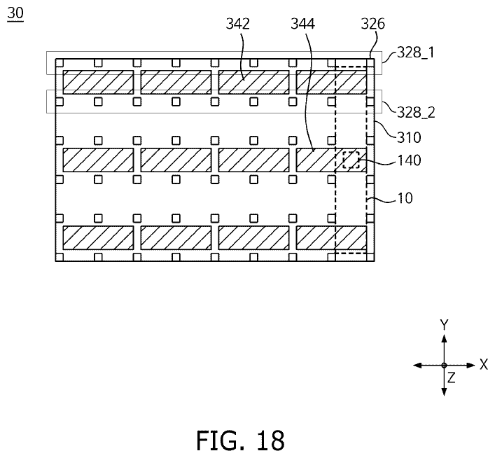

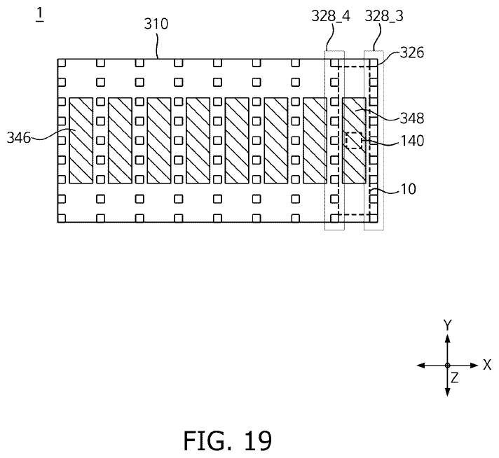

FIGS. 18 and 19 illustrate embodiments in which resin material regions 342, 344, 346, and 348 are provided in a region of the housing cover 30 in an embodiment of the housing cover 30 provided with the columnar heat dissipating fins 326.

FIG. 18 illustrates a plan diagram showing the housing cover 30 including the resin material regions 342 and 344 according to embodiments of the present disclosure. According to an embodiment, the resin material regions 342 and 344 may be provided on the heat dissipating plate 310 to extend in the longitudinal direction (e.g., the X-axis direction) of the battery module. Referring to FIG. 18, the resin material regions 342 and 344 may be provided between a first group of heat dissipating fins 328_1 and an adjacent second group of heat dissipating fins 328_2 among the heat dissipating fins 326 arranged in the longitudinal direction (e.g., the X-axis direction) of the battery module such that the resin material regions 342 and 344 extend in the longitudinal direction (e.g., the X-axis direction) of the battery module.

According to an embodiment, the position of one resin material region 344 among the resin material regions 342 and 344 may correspond to the position of the vent 140 provided in the battery cell 10 when the housing cover 30 is coupled to the upper portion of the module housing. For example, the resin material region 344 provided to extend in the longitudinal direction of the battery module between the first group of heat dissipating fins 328_1 and the adjacent second group of heat dissipating fins 328_2 may correspond to the position of the vent 140 provided in the battery cell 10. The resin material region 344 may be configured to be melted, sublimated, or dissolved by gases exhausting through the vent 140 so that the vent 140 is opened.

According to the configurations described above, at least a portion of the housing cover 30 to may be opened by thermal events in the battery cells, and heat generated by the battery module may be efficiently dissipated through the open portion.

FIG. 19 illustrates a plan diagram showing the housing cover 30 including the resin material regions 346 and 348 according to embodiments of the present disclosure. According to an embodiment, the resin material regions 346 and 348 may be provided on the heat dissipating plate 310 to extend in the transverse direction of the battery module (e.g., in the Y-axis direction). Referring to FIG. 19, the resin material regions 346 and 348 may be provided between a third group of heat dissipating fins 328_3 and an adjacent fourth group of heat dissipating fins 328_4 among the heat dissipating fins 326 arranged in the transverse direction (e.g., the Y-axis direction) of the battery module such that the resin material regions 346 and 348 extend in the transverse direction (e.g., the Y-axis direction) of the battery module.

According to an embodiment, the position of one resin material region 348 among the resin material regions 346 and 348 may correspond to the position of the vent 140 provided in the battery cell 10 when the housing cover 30 is coupled to the upper portion of the module housing. The resin material region 348 provided to extend in the transverse direction of the battery module between the third group of heat dissipating fins 328_3 and the adjacent fourth group of heat dissipating fins 328_4 may correspond to the position of the vent 140 provided in the battery cell 10. In this case, the resin material region 344 may be configured to be melted, sublimated, or dissolved by gases exhausting through the vent 140 so that the vent 140 is opened.

According to the configurations described above, at least a portion of the housing cover 30 may be opened due to thermal events in the battery cells, and the heat generated by the battery module can be efficiently dissipated through the open portion.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF REFERENCE SYMBOLS

100: battery cell
110: case
120: cap plate
130: terminal
140: vent
150: electrolyte inlet

What is claimed is:

1. A battery module comprising:
a battery cell;
a module housing accommodating the battery cell and comprising an open upper portion; and
a housing cover coupled to the upper portion of the module housing and comprising a plurality of heat dissipating fins.

2. The battery module as claimed in claim 1, wherein at least one heat dissipating fin of the heat dissipating fins extends in a longitudinal direction of the battery module and protrudes from a surface of the housing cover, and
wherein a first heat dissipating fin of the heat dissipating fins is spaced from a second heat dissipating fin of the heat dissipating fins that is adjacent to the first heat dissipating fin in a transverse direction of the battery module.

3. The battery module as claimed in claim 1, wherein at least one heat dissipating fin of the heat dissipating fins extends in a transverse direction of the battery module and protrudes from a surface of the housing cover, and
wherein a first heat dissipating fin of the heat dissipating fins is spaced from a second heat dissipating fin of the heat dissipating fins that is adjacent to the first heat dissipating fin in a longitudinal direction of the battery module.

4. The battery module as claimed in claim 1, wherein at least one heat dissipating fin of the heat dissipating fins is columnar, and
wherein the heat dissipating fins are spaced from each other and protrude from a surface of the housing cover.

5. The battery module as claimed in claim 1, wherein the housing cover comprises a resin material region.

6. The battery module as claimed in claim 5, wherein a position of the resin material region corresponds to a position of a vent provided in the battery cell when the housing cover is coupled to the open upper portion of the module housing.

7. The battery module as claimed in claim 5, wherein the resin material region is configured to melted, sublimated, or dissolved by gases exhausting through a vent provided in the battery cell.

8. The battery module as claimed in claim 5, wherein the resin material region is configured to be melted, sublimated, or dissolved when a thermal event occurs in the battery cell accommodated in the module housing.

9. The battery module as claimed in claim 5, wherein at least one heat dissipating fin of the heat dissipating fins extends in a longitudinal direction of the battery module and protrudes from a surface of the housing cover, and
wherein the resin material region is provided between a first heat dissipating fin of the heat dissipating fins and a second heat dissipating fin of the heat dissipating fins that is adjacent to the first heat dissipating fin, and the resin material region extends in a longitudinal direction of the battery module.

10. The battery module as claimed in claim 5, wherein at least one heat dissipating fin among the heat dissipating fins extends in a transverse direction of the battery module and protrudes from a surface of the housing cover, and
wherein the resin material region is provided between a first heat dissipating fin of the heat dissipating fins and a second heat dissipating fin of the heat dissipating fins that is adjacent to the first heat dissipating fin, and the resin material region extends in the transverse direction of the battery module.

11. The battery module as claimed in claim 5, wherein at least one heat dissipating fin of the heat dissipating fins is columnar, and
wherein the resin material region is provided between a first group of the heat dissipating fins and a second group of the heat dissipating fins arranged in a longitudinal direction of the battery module, and the resin material region extends in the longitudinal direction of the battery module.

12. The battery module as claimed in claim 5, wherein at least one heat dissipating fin of the heat dissipating fins is columnar, and
wherein the resin material region is provided between a first group of heat dissipating fins and a second group of heat dissipating fins among the heat dissipating fins arranged in a transverse direction of the battery module.

13. A housing cover coupled to an upper portion of a module housing configured to accommodate a battery cell, the housing cover comprising:
a heat dissipating plate including at least one resin material region; and
a plurality of heat dissipating fins protruding from an upper portion of the heat dissipating plate.

14. The housing cover as claimed in claim 13, wherein the resin material region is provided in at least a region of the heat dissipating plate between the heat dissipating fins.

15. The housing cover as claimed in claim 13, wherein the resin material region comprises a plurality of resin material regions,
wherein each resin material region of the resin material regions is arranged in at least a region of the heat dissipating plate between the heat dissipating fins and spaced from adjacent resin material regions.

16. The housing cover as claimed in claim 13, wherein a position of the resin material region corresponds to a position of a vent provided in the battery cell when the housing cover is coupled to an upper portion of the module housing and the battery cell is accommodated in the module housing.

17. The housing cover as claimed in claim 13, wherein the resin material region is configured to be melted, sublimated, or dissolved by gases exhausting through a vent provided in the battery cell.

18. The housing cover as claimed in claim 13, wherein the resin material region is configured to be melted, sublimated, or dissolved due when a thermal event occurs in the battery cell accommodated in the module housing.

19. A battery pack comprising:
a battery module accommodating a battery cell;
a pack housing configured to accommodate the battery module and comprising an open upper portion; and
a pack housing cover coupled to an upper portion of the pack housing and comprising a plurality of heat dissipating fins protruding from an upper portion of a heat dissipating plate.

20. The battery pack as claimed in claim 19, wherein the pack housing cover comprises a resin material region provided in at least a region of the heat dissipating plate between the heat dissipating fins.
